(19) United States
(12) Patent Application Publication
(10) Pub. No.: US 2013/0105400 A1
(43) Pub. Date: May 2, 2013

(54) COMPOSITE CONTAINING METAL COMPONENT SUPPORTED ON GRAPHENE, PREPARING METHOD OF THE SAME, AND USES OF THE SAME

(71) Applicants: Hyoyoung LEE, Suwon-si (KR); Prasenjit BHUNIA, Suwon-si (KR)

(72) Inventors: Hyoyoung LEE, Suwon-si (KR); Prasenjit BHUNIA, Suwon-si (KR)

(21) Appl. No.: 13/644,797

(22) Filed: Oct. 4, 2012

(30) Foreign Application Priority Data
Oct. 4, 2011 (KR) 10-2011-0100845

(51) Int. Cl. B01J 20/20; B01J 20/30

(52) U.S. Cl. CPC B01J 20/205; B01J 20/3078; Y10S 977/734; B82Y 30/00
USPC 210/688; 428/457; 428/702; 428/408; 428/304.4; 210/660; 210/681; 210/690; 252/175; 977/734

(57) ABSTRACT

There are provided a composite including a metal component supported on graphene, a preparing method of the same, and uses of the same. The composite may be used for removing a contaminant.

### CROSS-REFERENCE TO RELATED APPLICATION

This application claims the benefit of Korean Patent Application No. 2011-0100845 filed on Oct. 4, 2011, the entire disclosures of which are incorporated herein by reference.

### FIELD OF THE INVENTION

The present disclosure relates to a composite including a metal component supported on graphene, a preparing method of the same, and uses of the same.

### BACKGROUND OF THE INVENTION

Conventionally, an ion exchange method, a coagulation (coprecipitation) method, a reverse osmosis method, a bioremediation method, and an adsorption method have been used to remove arsenic (As). Of these, the adsorption method has usually been used to remove arsenic from drinking water due to its technical and cost advantages. Iron has a high adsorption for arsenate and arsenite as arsenic-based materials. Typically, triiron tetraoxide (Fe₃O₄) have been used to remove arsenic from drinking water contaminated with arsenic. Some kinds of zero-valent iron (ZVI) are used. ZVI has a stronger affinity for arsenic as compared with other normal iron-based materials. Typically, however, the ZVI exists in the form of very fine powder. Thus, if it is directly used in a water treatment system, it can be rapidly washed away in a continuous flow system. If it is exposed to the atmosphere, it is rapidly oxidized and thus cannot be used. In order to solve such problems, many researchers have studied about synthesis of ZVI supported on activated carbon. In a thesis entitled “Carbothermal synthesis of carbon-supported nanoscale zero-valent iron particles for the remediation of hexavalent chromium” published in Environ. Sci. Technol. in 2008, the researchers use nanoscale zero-valent iron supported on activated carbon to remove hexavalent chromium. In a thesis entitled “Removal of arsenic from water by supported nano zero-valent iron on activated carbon” published in J. of Hazardous Materials in 2009, the researchers use zero-valent iron supported on activated carbon to remove arsenic.

Besides, there are some studies about nanoscale ZVI (hereinafter, referred to as “nZVI”). In a thesis entitled “Removal of arsenic(III) from groundwater by nanoscale zero-valent iron” published in Environ. Sci. Technol. in 2005, the researchers use nZVI to remove arsenic from groundwater. However, as described above, if the nZVI is exposed to the atmosphere, it is rapidly oxidized and thus cannot be used. As a solution to this problem, Korean Patent No. 10-0874709 describes a method for synthesis of zero-valent iron nanowires (INW) comprising reducing ferrous sulfate mixed with poly vinyl pyrrolidone (PVP) by adding sodium borohydride as a reducer and its application for removing arsenic, chromium, and trichloroethylene. In Korean Patent No. 10-0766819, it is descried that air-stable nZVI having an oxide layer in its outer shell is synthesized and the synthesized nZVI is used to remove trichloroethylene, tetrachloroethylene, and arsenic. Korean Patent No. 10-1027139 describes polyphenol-coated nZVI having high reaction stability, high dispersibility, and high mobility and it application for removing heavy metals, nitrates, sulfates, and organic halide contaminants. Korean Publication No. 10-2010-0097490 describes that nZVI is washed with ethanol and freeze-dried to prepare nZVI having an oxide layer in its outer shell and the prepared nZVI can be used to remove trichloroethylene, chromium, lead, arsenic, and bromic acid. Korean Publication No. 10-2010-0131288 describes that a film mainly made of triiron tetraoxide is formed on a surface of a nZVI by exposing the surface of the nZVI to a small amount of air to prepare a particle and the nZVI particle can be used to remove trichloroethylene, carbon tetrachloride, and nitrates.

As described above, there are a lot of studies to use ZVI to remove contaminants such as arsenic. However, when ZVI supported on activated carbon is used, the amount of ZVI is relatively smaller as compared with a case where only ZVI is used. Therefore, efficiency for removing contaminants is reduced. Further, if only nZVI is used to remove contaminants, efficiency is high but water may be contaminated with iron ions. If nZVI is used as a column filler in a typical water treatment system, it makes a strong interaction with water due to its nanoscale size, and thus, contaminated water cannot pass through the column filler and the nZVI is easily washed away by a flow of the water. If a method of removing super paramagnetic nZVI with a magnetic field is applied to a water treatment system, a column cannot be used and a container to hold contaminated water is needed. Thus, the water treatment system is not suitable for continuous purification of contaminated water and cannot perform a purification process in large amounts.

In order to solve these problems, a material including nZVI needs to be stabilized in the air, each particle of nZVI needs to be directly exposed to contaminants, and the material including nZVI needs to have particles of a microscale size or greater so as to be easily used as a material of a column.

### BRIEF SUMMARY OF THE INVENTION

In view of the foregoing, the present disclosure provides a composite including a metal component supported on graphene, wherein the metal component includes zero-valent metal, an oxide of the metal, or a mixture of the zero-valent metal and the oxide of the metal and also provides a preparing method of the composite.

Further, the present disclosure provides a composition for removing a contaminant including the composite and a method of removing a contaminant comprising adsorbing and removing contaminants by using the composite.

However, the problems to be solved by the present disclosure are not limited to the above description and other problems can be clearly understood by those skilled in the art from the following description.

In accordance with a first aspect of the present disclosure, there is provided a composite including a metal component supported on graphene, wherein the metal component comprises zero-valent metal, an oxide of the metal, or a mixture of the zero-valent metal and the oxide of the metal.

In accordance with a second aspect of the present disclosure, there is provided a composition for removing a contaminant comprising the composite in accordance with a first aspect of the present disclosure.

In accordance with a third aspect of the present disclosure, there is provided method of removing a contaminant, comprising adsorbing and removing a contaminant by using the composite in accordance with a first aspect of the present disclosure.

In accordance with a fourth aspect of the present disclosure, there is provided a method of preparing the composite in accordance with a first aspect of the present disclosure.

In accordance with the present disclosure, a composite including a metal component supported on graphene can be mass-produced through a solution process and a heating and reducing process. Further, a composite prepared by the method in accordance with the present disclosure has a high quality. The composite is well dispersed in water or an organic solvent and easily adsorbs contaminants including a heavy metal, an inorganic contaminant, an organic contaminant, a microorganism, and the like. The composite is stable in the air and can be used to provide a contaminant removing composition for purifying water or an organic solvent contaminated with the contaminants and a method of removing a contaminant using the same composition.

An iron oxide cannot be reduced to zero-valent iron through a conventional heating process only. However, if a reducing process is performed at an appropriate temperature by using an inert gas including some hydrogen in accordance with the present disclosure, it is possible to reduce an iron oxide at a high yield. In accordance with the present disclosure, during reduction of iron through a heating process, a structure of the composite including the iron component supported on graphene and a valency of the iron component can be adjusted depending on a heating process temperature and an atmosphere. Thus, porosity of the composite can be adjusted and adsorption of contaminants can be adjusted or improved.

In accordance with the present disclosure, if the iron component supported on graphene includes zero-valent iron or an iron oxide together with the zero-valent iron, adsorption of heavy metals is improved. In particular, if the iron component includes the iron oxide together with the zero-valent iron, porosity of the composite is increased and thus the adsorption capability can be improved. The composite including the iron component supported on graphene in accordance with the present disclosure is well dispersed in water or an organic solvent, and after the composite adsorbs contaminants such as heavy metals in water, it is possible to easily remove the composite that adsorbs the contaminants by using magnetism of the iron component included in the composite.

The composite in accordance with the present disclosure may include the above-described iron components, zero-valent metal selected from the group consisting of Pd, Pt, Au, Ru, Ir, Rd, Ti, Co, Ni, Cu, Zn, Cr, V, Al, Sn, In, Ce, Mo, Ag, Se, Te, Y, Eu, Nb, Sm, Nd, Ga, Gd, and combinations thereof, an oxide of the metal, or a mixture of the zero-valent metal and the oxide of the metal. In accordance with the present disclosure, if the metal component supported on graphene includes zero-valent metal or an oxide of the metal together with the zero-valent metal, adsorption of heavy metals is improved. In particular, if the metal component includes the oxide of the metal together with the zero-valent metal, porosity of the composite is increased and the adsorption capability can be improved accordingly. The composite including the metal component supported on graphene in accordance with the present disclosure is well dispersed in water or an organic solvent, and after the composite adsorbs contaminants such as heavy metals in water, it is possible to easily remove the composite that adsorbs the contaminants by using magnetism of the metal component included in the composite.

The composite including the metal component supported on graphene in accordance with the present disclosure can be used to adsorb and remove a contaminant including a heavy metal or a cation thereof, an organic contaminant, an inorganic contaminant, and combinations thereof. To be specific, it is possible to easily and efficiently remove a contaminant comprising a heavy metal including arsenic (As), chromium (Cr), lead (Pb), cadmium (Cd), mercury (Hg), and combinations thereof or a cation thereof; an organic contaminant selected from the group consisting of methylene blue, methyl orange, trichloroethylene (TCE), tetrachloroethylene (PCE), polychlorinated biphenyl (PCBs), carbon tetrachloride, and combinations thereof; an inorganic contaminant including perchlorate, nitrate, phosphate, carbonate, sulfate, hydrogen fluoride, hydrochloric acid, bromic acid, acetic acid, and combinations thereof; and an microorganism including a virus, bacteria and the like from water or an organic solvent including the contaminants.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is molecular structures of reduced graphene oxide-supported triiron tetraoxide (RGO-Fe₃O₄), reduced graphene oxide-supported triiron tetraoxide-zero-valent iron (RGO-Fe₃O₄/ZVI), and reduced graphene oxide-supported zero-valent iron (RGO-ZVI) in accordance with an embodiment of the present disclosure;

FIG. 2 is a schematic diagram illustrating a process of forming a composite by supporting an iron component on a graphene oxide in accordance with an example of the present disclosure;

FIG. 3 is a scanning electron micrograph and an EDAX (Energy Dispersive Analysis of X-ray) graph of a composite including an iron component supported on a graphene oxide in accordance with an example of the present disclosure;

FIG. 4 is an XRD graph illustrating that a composite including an iron component supported on a graphene oxide is changed into zero-valent iron through a heating process in accordance with an example of the present disclosure;

FIG. 5 is a Mössbauer analysis graph illustrating that a composite including an iron component supported on a graphene oxide is changed into zero-valent iron through a heating process in accordance with an example of the present disclosure;

FIG. 6 is a Raman analysis graph illustrating that a composite including an iron component supported on a reduced graphene oxide is changed through a heating process in accordance with an example of the present disclosure;

FIG. 7 is an infrared specectroscopic analysis graph illustrating that a composite including an iron component supported on a reduced graphene oxide is changed through a heating process in accordance with an example of the present disclosure;

FIG. 8 provides magnetic hysteresisloop graphs illustrating that a composite including an iron component supported on a reduced graphene oxide is changed through a heating process in accordance with an example of the present disclosure;

FIG. 9 provides photos showing that a composite including an iron component supported on a reduced graphene oxide is heat-processed at about 400° C. and dispersed in water and separated by using a magnetic field in accordance with an example of the present disclosure;

FIG. 10 is a graph showing a concentration of adsorbed arsenic of composites including an iron component supported on a reduced graphene oxide in accordance with an example of the present disclosure;

FIG. 11 is a graph showing a relationship between a quantity (Qe) of adsorbed arsenic per adsorbent and an equilibrium concentration (Ce) when composites including an iron component supported on a reduced graphene oxide are used as an adsorbent in accordance with an example of the present disclosure;

FIG. 12 is a graph showing maximum arsenic adsorption amounts of composites including an iron component supported on a reduced graphene oxide in accordance with an example of the present disclosure;

FIG. 13 is a graph showing a relationship between an adsorbed quantity (Qe) of arsenic (As), chromium (Cr), lead (Pb), cadmium (Cd), and mercury (Hg) and an equilibrium concentration (Ce) when a composite including an iron component supported on a reduced graphene oxide is used as an adsorbents of a heavy metal in accordance with an example of the present disclosure;

FIG. 14 is a graph showing a relationship between an adsorbed quantity (Qe) of methylene blue or methyl orange and an equilibrium concentration (Ce) when a composite including an iron component supported on a reduced graphene oxide is used as an adsorbents of methylene blue or methyl orange which is an organic contaminant in accordance with an example of the present disclosure; and

FIG. 15 is a schematic diagram of an apparatus for processing PAX-21 waste water by using a composite including an iron component supported on a reduced graphene oxide in accordance with an example of the present disclosure.

### DETAILED DESCRIPTION OF THE INVENTION

Hereinafter, examples of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the another element and a case that any other element exists between these two elements.

Further, the term “comprises or includes” and/or “comprising or including” used in the document means that one or more other components, steps, operation and/or existence or addition of elements are not excluded in addition to the described components, steps, operation and/or elements unless context dictates otherwise.

The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

In accordance with a first aspect of the present disclosure, a composite including a metal component supported on graphene, wherein the metal component comprises zero-valent metal, an oxide of the metal, or a mixture of the zero-valent metal and the oxide of the metal, but it is not limited thereto.

In accordance with an illustrative embodiment of the present disclosure, the graphene includes, but not limited to, a reduced graphene oxide.

In accordance with an illustrative embodiment of the present disclosure, the metal component includes zero-valent metal selected from the group consisting of Fe, Pd, Pt, Au, Ru, Ir, Rd, Ti, Co, Ni, Cu, Zn, Cr, V, Al, Sn, In, Ce, Mo, Ag, Se, Te, Y, Eu, Nb, Sm, Nd, Ga, Gd, and combinations thereof, an oxide of the metal, or a mixture of the zero-valent metal and the oxide of the metal, but it is not limited thereto.

In accordance with an illustrative embodiment of the present disclosure, the metal component includes, but not limited to, the zero-valent metal or the mixture of the zero-valent metal and the oxide of the metal. By way of example, the composite may include, but is not limited to, zero-valent iron (ZVI) supported on the reduced graphene oxide or a mixture of an iron oxide and the zero-valent iron.

In accordance with an illustrative embodiment of the present disclosure, if the metal component includes the mixture of the oxide of the metal and the zero-valent metal, a weight ratio of the oxide of the metal to the zero-valent metal is, in a range of from about 1:1 to about 1:5.

In accordance with an illustrative embodiment of the present disclosure, the graphene includes a multiple number of graphene layers, and the metal component is intercalated between the graphene layers or supported on surfaces of the graphene layers, but they are not limited thereto.

By way of example, the oxide of the metal as the metal component is intercalated between layers of the graphene and the zero-valent metal as the metal component is supported on surfaces of the graphene layers, but they are not limited thereto. Since the oxide of the metal is intercalated between the graphene layers, a gap between the graphene layers is increased and porosity of the composite is increased. Therefore, if the composite includes the mixture of the zero-valent metal and the oxide of the metal, the porosity of the composite can be further increased. Since the oxide of the metal is intercalated between the graphene layers, a diameter of a pore formed in the composite may be in the unit of nanometer and in a range of, for example, but not limited to, from about 1 nm to about 100 nm, from about 1 nm to about 90 nm, from about 1 nm to about 80 nm, from about 1 nm to about 70 nm, from about 1 nm to about 60 nm, from about 1 nm to about 50 nm, from about 1 nm to about 40 nm, from about 1 nm to about 30 nm, from about 1 nm to about 20 nm, from about 1 nm to about 10 nm, or from about 1 nm to about 5 nm.

By way of example, the composite may include, but is not limited to, zero-valent iron (ZVI) supported on the reduced graphene oxide or a mixture of an iron oxide and the zero-valent iron. If the composite includes the mixture of the iron oxide and the zero-valent iron, the porosity can be further increased as compared with a case where the composite includes the zero-valent iron only. In this regard, if the metal component includes the mixture of the zero-valent iron and the iron oxide, the iron oxide is intercalated between the reduced graphene oxide layers and the zero-valent iron may be supported on surfaces of the reduced graphene oxide layers. The iron oxide intercalated between the reduced graphene oxide layers may cause a further increase in the porosity of the composite.

In accordance with an illustrative embodiment of the present disclosure, the metal component is formed in, but not limited to, nanoparticles. By way of example, each of the oxide of the metal and the zero-valent metal may be formed in, but not limited to, nanoparticles. Each of the oxide of the metal and the zero-valent metal may have nanoparticles having a diameter of about 1 nm or more or about 10 nm or more, respectively. By way of example, the nanoparticle is in a range of, but not limited to, from about 1 nm to about 1,000 nm, from about 1 nm to about 900 nm, from about 1 nm to about 800 nm, from about 1 nm to about 700 nm, from about 1 nm to about 600 nm, from about 1 nm to about 500 nm, from about 1 nm to about 400 nm, from about 1 nm to about 300 nm, from about 1 nm to about 200 nm, from about 1 nm to about 100 nm, from about 1 nm to about 50 nm, from about 10 nm to about 1,000 nm, from about 10 nm to about 900 nm, from about 10 nm to about 800 nm, from about 10 nm to about 700 nm, from about 10 nm to about 600 nm, from about 10 nm to about 500 nm, from about 10 nm to about 400 nm, from about 10 nm to about 300 nm, from about 10 nm to about 200 nm, from about 10 nm to about 100 nm, or from about 10 nm to about 50 nm.

In accordance with a second aspect of the present disclosure, there is provided a composition for removing a contaminant comprising the composite of a first aspect of the present disclosure, but it is not limited thereto.

In accordance with an illustrative embodiment of the present disclosure, the contaminant removing composition is used to, but not limited to, remove a contaminant included in water or an organic solvent.

In accordance with an illustrative embodiment of the present disclosure, the contaminant is selected from the group consisting of a heavy metal or a cation thereof, an organic contaminant, an inorganic contaminant, a microorganism, and combinations thereof, but it is not limited thereto.

In accordance with an illustrative embodiment of the present disclosure, the heavy metal or the cation thereof is, but not limited to, metal or its cation selected from the group consisting of arsenic (As), chromium (Cr), lead (Pb), cadmium (Cd), mercury (Hg), and combinations thereof.

In accordance with an illustrative embodiment of the present disclosure, the organic contaminant is selected from the group consisting of methylene blue, methyl orange, trichloroethylene (TCE), tetrachloroethylene (PCE), polychlorinated biphenyl (PCBs), carbon tetrachloride, and combinations thereof, the inorganic contaminant is selected from the group consisting of perchlorate, nitrate, phosphate, carbonate, sulfate, hydrogen fluoride, hydrochloric acid, bromic acid, acetic acid, and combinations thereof, and the microorganism includes a virus or a bacteria, but they are not limited thereto.

In accordance with a third aspect of the present disclosure, there is provided a method of removing a contaminant, including adsorbing and removing a contaminant by using the composite of a first aspect of the present disclosure, but it is not limited thereto.

In accordance with an illustrative embodiment of the present disclosure, the contaminant is included, but not limited to, in water or an organic solvent.

In accordance with an illustrative embodiment of the present disclosure, the composite is filled, but not limited to, in a fixed-bed column or supported on a fixed-bed surface.

In accordance with an illustrative embodiment of the present disclosure, the contaminant is selected from the group consisting of a heavy metal or a cation thereof, an organic contaminant, an inorganic contaminant, a microorganism, and combinations thereof, but it is not limited thereto.

In accordance with an illustrative embodiment of the present disclosure, the heavy metal or the cation thereof is metal or its cation selected from the group consisting of arsenic (As), chromium (Cr), lead (Pb), cadmium (Cd), mercury (Hg), and combinations thereof, but they are not limited thereto.

In accordance with an illustrative embodiment of the present disclosure, the organic contaminant is selected from the group consisting of methylene blue, methyl orange, trichloroethylene (TCE), tetrachloroethylene (PCE), polychlorinated biphenyl (PCBs), carbon tetrachloride, and combinations thereof, the inorganic contaminant is selected from the group consisting of perchlorate, nitrate, phosphate, carbonate, sulfate, hydrogen fluoride, hydrochloric acid, bromic acid, acetic acid, and combinations thereof, and the microorganism includes a virus or a bacteria, but it is not limited thereto.

In accordance with an illustrative embodiment of the present disclosure, bacteria and virus can be inactivated by using a composite including graphene supporting an iron component including zero-valent iron by the method of the third aspect of the present disclosure. By way of example, the zero-valent iron affects a cell membrane of Escherichia coli (E-coli) under lack of oxygen and immediately inactivates the E-coli [App. Environ. Microbiology, November 2010, 7668-7670.]. Further, the zero-valent iron can inactivate MS2 colipharge [Environ. Sci. Technol. 2011, 45, 6978-6984.]. It has been known that such reaction is easily made by zero-valent iron rather than divalent or tetravalent iron. Thus, it is possible to effectively remove a microorganism contaminant including bacteria or virus by using the composite including the graphene supporting the iron component including the zero-valent iron in accordance with the illustrative embodiment of the present disclosure. That is, the water or the organic solvent including the microorganism including the bacteria or the virus is brought into contact with the composite including the graphene supporting the iron component including the zero-valent iron in accordance with the illustrative embodiment of the present disclosure, so that the bacteria or the virus can be inactivated by the zero-valent iron included in the composite and the microorganism contaminant can be removed effectively. By way of example, the inactivated microorganism contaminant may be adsorbed to the composite and removed, but it is not limited thereto. The bacteria may include, but are not limited to, various colon bacilli (non-limiting example: Escherichia coli and MS2 coliphage).

In accordance with an illustrative embodiment of the present disclosure, the method of the third aspect of the present disclosure may be used to decompose a toxic ingredient included in waste water, such as PAX-21, or help biodegradation of the toxic ingredient. By way of example, the PAX-21 waste water includes a toxic ingredient such as a nitro aromatic compound [reference: Microbes and Environments, Vol. 24 (2009), No. 1 pp. 72-75.]. The nitro aromatic compound as the toxic ingredient may include 2,4-dinitroanisole (DNAN), n-methyl-4-nitroaniline (MNA), and hexahydro-1,3,5-trinitro-1,3,5-trazine (RDX). Conventionally, the PAX-21 waste water was removed through biodegradation of perchlorate included in the PAX-21 waste water by using perchlorate respiring bacteria. However, it has been reported that the toxic ingredient such as the nitro aromatic compound included in the PAX-21 waste water affects a biodegradation rate of the perchlorate [Journal of Hazardous Materials 192 (2011) 909-914.].

Thus, in accordance with an illustrative embodiment, if the PAX-21 waste water is pre-processed by using the composite including the graphene supporting the iron component including the zero-valent iron in accordance with the illustrative embodiment of the present disclosure, the zero-valent iron reduces the toxic ingredient such as the nitro aromatic compound including 2,4-dinitroanisole (DNAN), n-methyl-4-nitroaniline (MNA), and hexahydro-1,3,5-trinitro-1,3,5-trazine (RDX) and thus may improve the biodegradation of the perchlorate using the perchlorate respiring bacteria.

In accordance with a fourth aspect of the present disclosure, there is provided a method of preparing the composite of a first aspect of the present disclosure, the method comprising: preparing an aqueous solution that includes a graphene oxide and a metal compound; reducing the graphene oxide by adding an alkaline solution as a reducer to the aqueous solution to obtain a mixed solution that includes a metal oxide supported on a reduced graphene oxide; removing a solvent included in the mixed solution to obtain a mixture including the metal oxide supported on the reduced graphene oxide; and heating the mixture including the metal oxide supported on the reduced graphene oxide to reduce all or a part of the metal oxide under a reducing atmosphere, but it is not limited thereto.

When the mixture including the oxide of the metal supported on the reduced graphene oxide is heated in a reduction atmosphere to reduce all or a part of the oxide of the metal, a reduction ratio of the oxide of the metal is determined by a ratio of the zero-valent metal to the oxide of the metal included in the composite to be obtained.

In accordance with an illustrative embodiment of the present disclosure, the method is performed in, but not limited to, an inert atmosphere.

In accordance with an illustrative embodiment of the present disclosure, the inert atmosphere includes, but not limited to, a nitrogen (N₂) gas, an argon (Ar) gas, or a helium (He) gas.

In accordance with an illustrative embodiment of the present disclosure, the reducing atmosphere during the heating includes, but not limited to, a hydrogen (H₂) gas, an argon (Ar) gas, or a mixed gas of hydrogen (H₂) and argon (Ar).

In accordance with an illustrative embodiment of the present disclosure, a heating temperature during the heating is in a range of, but not limited to, from about 400° C. to about 600° C.

In accordance with an illustrative embodiment of the present disclosure, a heating time during the heating is, but not limited to, about 5 hours or less. The heating time may include, for example, but not limited to, about 5 hours or less, about 4 hours or less, about 3 hours or less, about 2 hours or less, about 1 hour or less, from about 0.1 hour to about 5 hours, from about 0.1 hour to about 4 hours, from about 0.1 hour to about 3 hours, from about 0.1 hour to about 2 hours, from about 0.1 hour to about 1 hour, from about 1 hour to about 5 hours, from about 1 hour to about 4 hours, from about 1 hour to about 3 hours, from about 1 hour to about 2 hours, from about 2 hours to about 5 hours, from about 2 hours to about 4 hours, and from about 2 hours to about 3 hours.

In accordance with an illustrative embodiment of the present disclosure, the metal compound may include an iron compound. By way of example, the metal compound includes, but not limited to, a halide salt of the metal.

In accordance with an illustrative embodiment of the present disclosure, the reducer is selected from the group consisting of H₂, NaBH₄, SO₂, CH₄, NH₃, N₂H₄, H₂S, HI, and combinations thereof, but it is not limited thereto.

In accordance with an illustrative embodiment of the present disclosure, the removing of a solvent is performed by, but not limited to, using a centrifuge.

In accordance with an illustrative embodiment of the present disclosure, after the obtaining of the mixture including the metal oxide supported on the reduced graphene oxide, washing the mixture with an organic solvent, but the composite preparing method is not limited thereto.

In accordance with an illustrative embodiment of the present disclosure, the washing of the mixture with the organic solvent includes, but not limited to, an ultrasonication process.

Hereinafter, examples of the present disclosure will be explained in detail, but the present disclosure is not limited thereto.

### EXAMPLE

### Example 1

### Preparation of Composite

1. Preparation of Reduced Graphene Oxide-Supported Zero-Valent Iron (RGO-ZVI)

Above all, there was a process in which triiron tetraoxide (Fe₃O₄) was supported on a reduced graphene oxide. About 1 ml of 1 M FeCl₂ was put into a round flask filled with a nitrogen gas with stirring and a reduced graphene oxide aqueous solution having a concentration of 20 mg/5 ml was added thereto. Then, about 3 ml of a solution in which 1.6 M sodium borohydride (NaBH₄) dissolved in an alkaline solution set to about pH 10 by using NaOH was dropwisely added to slurry at a rate of 1 ml per minute at about 25° C. Thereafter, a resultant mixture was maintained at the same temperature in a nitrogen atmosphere for about 30 minutes. After a reaction was completed, it was centrifuged at about 5000 rpm for about 20 minutes in order to remove non-reacted FeCl₂ and NaBH₄ from the aqueous solution. The solvent was changed into acetone immediately and the centrifugation was continued in the same conditions. A supernatant was put into new acetone. Materials in the acetone was processed with ultrasonic waves for about 30 minutes and filtered through a Whatman membrane filter having holes of about 0.2 μm. The materials were dried in a vacuum oven for about 12 hours and resultantly, powder of triiron tetraoxide (Fe₃O₄) supported on a reduced graphene oxide (Fe₃O₄ supported on RGO) was obtained.

Then, there was a heating process for reducing the triiron tetraoxide supported on the reduced graphene oxide into the zero-valent iron. The powder of triiron tetraoxide supported on the reduced graphene oxide was put on an alumina (Al₂O₃) plate and the plate was put into a tube furnace. Thereafter, while an Ar mixed gas including about 4% H₂ flowed at a flow rate of about 200 ccpm, the furnace was heated up to about 600° C. with an increase by 5° C. per minute. After a temperature reached about 600° C., the heating process was performed at the same temperature for about 2 hours. Finally, reduced graphene oxide-supported zero-valent iron (RGO-ZVI) was handled in the air for measurement and other applications thereof.

2. Preparation of Reduced Graphene Oxide-Supported Triiron Tetraoxide (RGO-Fe₃O₄)

A process was performed in the same manner as the preparation method of the reduced graphene oxide-supported zero-valent iron except that the heating process was omitted.

3. Preparation of Reduced Graphene Oxide-Supported Triiron Tetraoxide-Zero-Valent Iron (RGO-Fe₃O₄/ZVI)

A process was performed in the same manner as above-mentioned preparation method of the reduced graphene oxide-supported zero-valent iron except that a heating process was performed at a temperature in a range of from about 300° C. to about 600° C. while an Ar mixed gas including about 4% H₂ flowed at a flow rate of about 200 ccpm.

### Example 2

### Removal of Heavy Metal with Composite

An experiment for removing heavy metals such as arsenic (As), chromium (Cr), lead (Pb), cadmium (Cd), and mercury (Hg) was carried out by using the composite including the iron component supported on graphene prepared in Example 1.

To be specific, each of arsenic oxide (As₂O₃), chromium oxide (CrO₃), lead nitrate (PbNO₃), cadmium chloride (CdCl₂), and mercury chloride (HgCl₂) was used as a reactant.

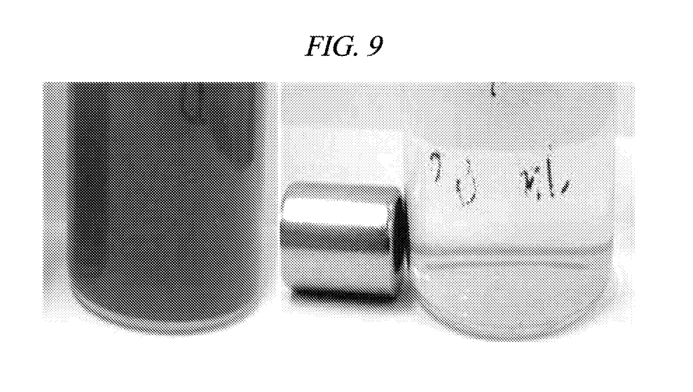

Above all, an aqueous solution in which an arsenic oxide (As₂O₃) dissolved at a concentration of about 10 ppm was put into a glass beaker. Samples of the composite including the iron component supported on graphene heat-processed at about 400° C. and 600° C. were dispersed in water at a concentration of about 0.7 mg/ml and could be separated from the water by using a magnet (FIG. 9). The separation of the composite including the iron component supported on graphene prepared in Example 1 was nearly completed with a magnetic field of about 20 mT within about 30 seconds. About 0.1 mg, about 0.5 mg, about 1 mg, about 2 mg, and about 4 mg of the composite including the iron component supported on graphene were respectively added into about 10 ml of 10 ppm arsenic oxide aqueous solution. Each solution was processed with ultrasonic waves for about 5 minutes and left as such for about 55 minutes. Then, the composite including the iron component supported on graphene was separated from the solution by using a magnet. A concentration of As(III) was measured with an inductively coupled plasma-optical emission spectrometer (ICP-OES).

Experiments for removing a chromium oxide (CrO₃), lead nitrate (PbNO₃), cadmium chloride (CdCl₂), and mercury chloride (HgCl₂) were carried out in the same manner as the experiment of the arsenic oxide (As₂O₃).

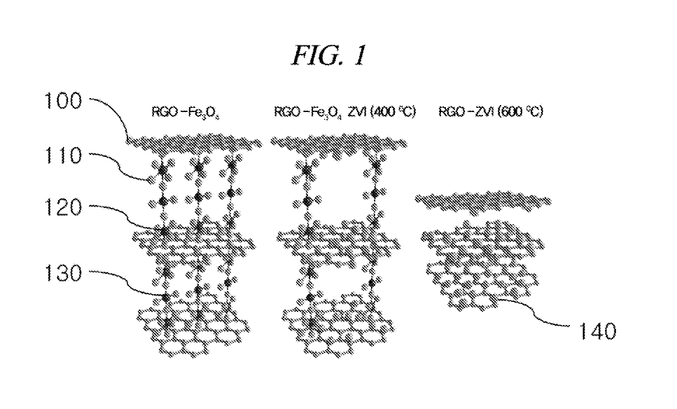

FIG. 1 provides structures of reduced graphene oxide-supported triiron tetraoxide (RGO-Fe₃O₄), reduced graphene oxide-supported triiron tetraoxide-zero-valent iron (RGO-Fe₃O₄/ZVI), and reduced graphene oxide-supported zero-valent iron (RGO-ZVI) in accordance with the present example. As depicted in FIG. 1, each of reduced graphene oxide-supported triiron tetraoxide, a composite including an iron component including reduced graphene oxide-supported triiron tetraoxide-zero-valent iron, and a composite including an iron component supported on graphene including reduced graphene oxide-supported zero-valent iron may have a structure including, but not limited to, a two-dimensional plate-shaped graphene sheet 100 with carbon atoms in a hexagonal honeycomb shape; green oxygen anions 110, blue bivalent or trivalent octahedral iron (Fe) ions 120; red trivalent tetrahedral iron ions 130, and orange zero-valent iron 140.

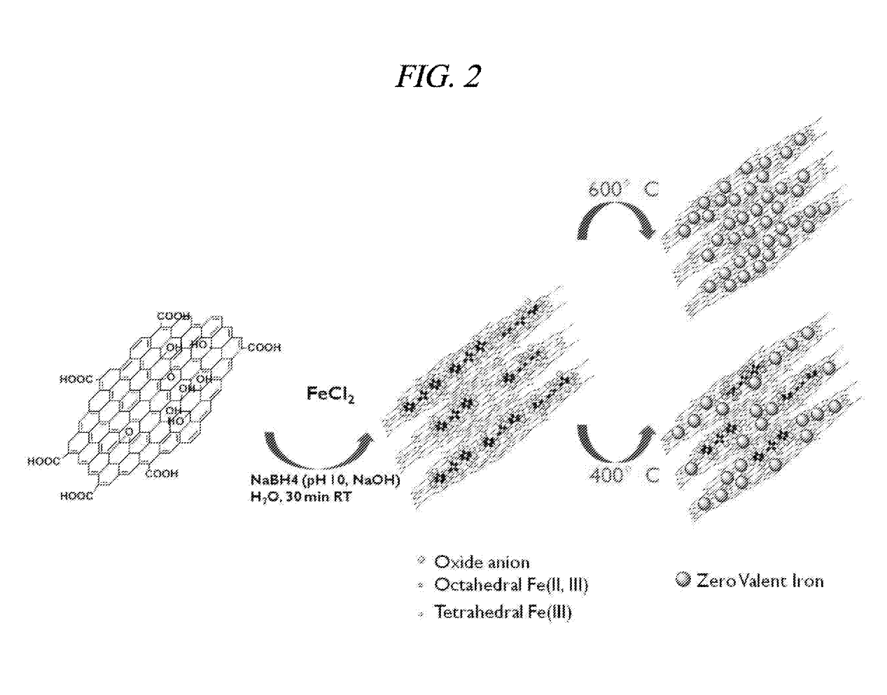

FIG. 2 is a schematic diagram illustrating a process of preparing the composite by forming the iron component to be supported on the graphene oxide in accordance with the present example. On the left of FIG. 2, a graphene oxide in a hexagonal honeycomb shape to which OH, COOH, epoxy groups are bonded is shown. In the middle of FIG. 2, triiron tetraoxide (Fe₃O₄) supported on a reduced graphene oxide is shown. Two drawings on the right of FIG. 2 show that triiron tetraoxide is reduced into zero-valent iron differently depending on a temperature of a heating process and shows that triiron tetraoxide is completely reduced into zero-valent iron when a heating process is performed at about 600° C.

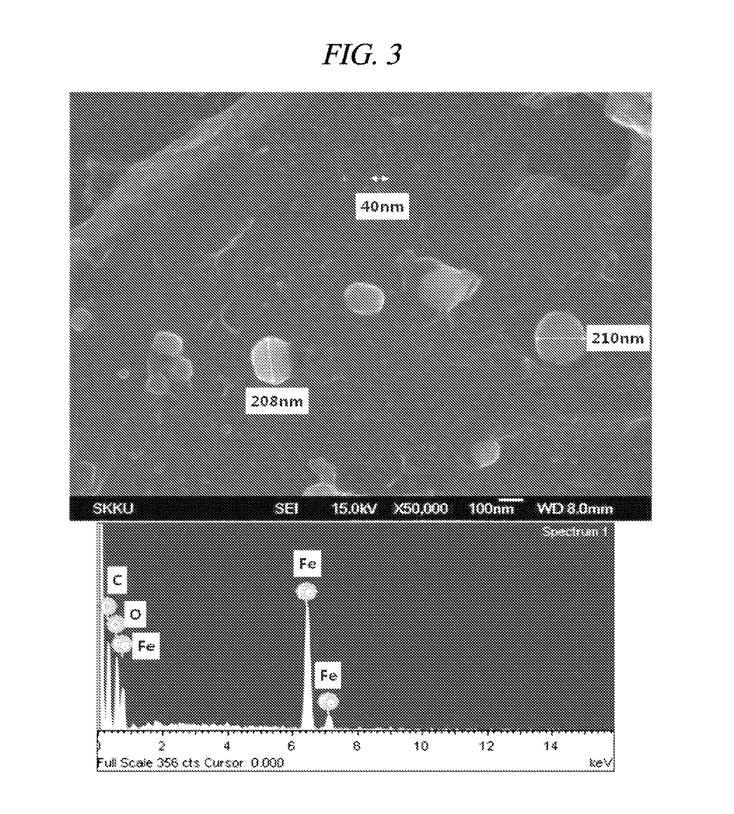

FIG. 3 is a scanning electron micrograph (upper part) and an EDAX (Energy Dispersive Analysis of X-ray) graph (lower part) of the composite including the iron component supported on the graphene oxide in accordance with the present example. The scanning electron micrograph shows that iron nanoparticles each having a diameter in a range of from about 40 nm to about 210 nm are supported on reduced graphene oxide. The EDAX graph shows that the structure shown in the scanning electron micrograph includes carbon (C), oxygen (O), and iron (Fe).

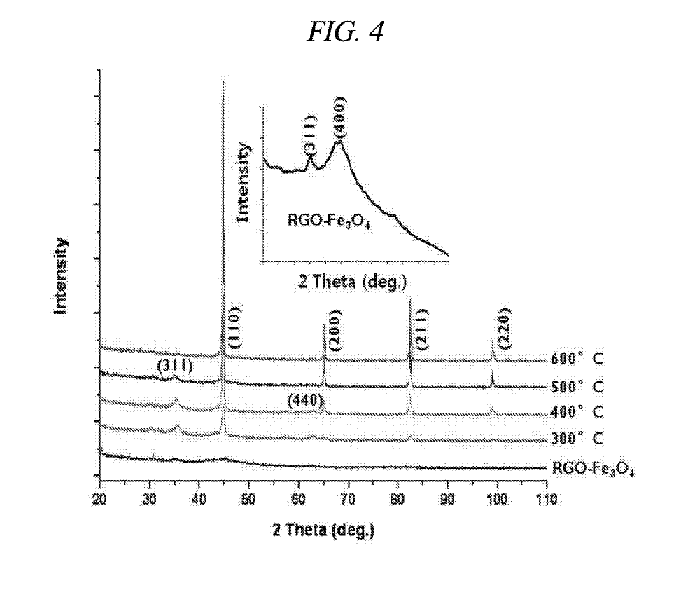

FIG. 4 is an XRD graph illustrating that the composite including the iron component supported on the graphene oxide is changed into zero-valent iron through a heating process in accordance with an the present example. In the graph of reduced graphene oxide-supported triiron tetraoxide (RGO-Fe₃O₄) and composites including an iron component supported on graphene obtained from the reduced graphene oxide-supported triiron tetraoxide (RGO-Fe₃O₄) through a heating process at about 300° C., about 400° C., about 500° C., and about 600° C., respectively, a peak when 2 Theta (θ) is about 44.5° corresponds to (110) of the zero-valent iron having a bcc crystal structure. The graph shows that since an intensity of the peak is increased as a temperature of the heating process is increased, crystallinity is increased. Further, a peak when 2 Theta (θ) is about 35.1° corresponds to (311) of a crystal structure of triiron tetraoxide (Fe₃O₄). A peak of a sample heat-processed at about 600° C. was completely removed. That is, it can be seen that reduction of the triiron tetraoxide into the zero-valent iron depends on a temperature.

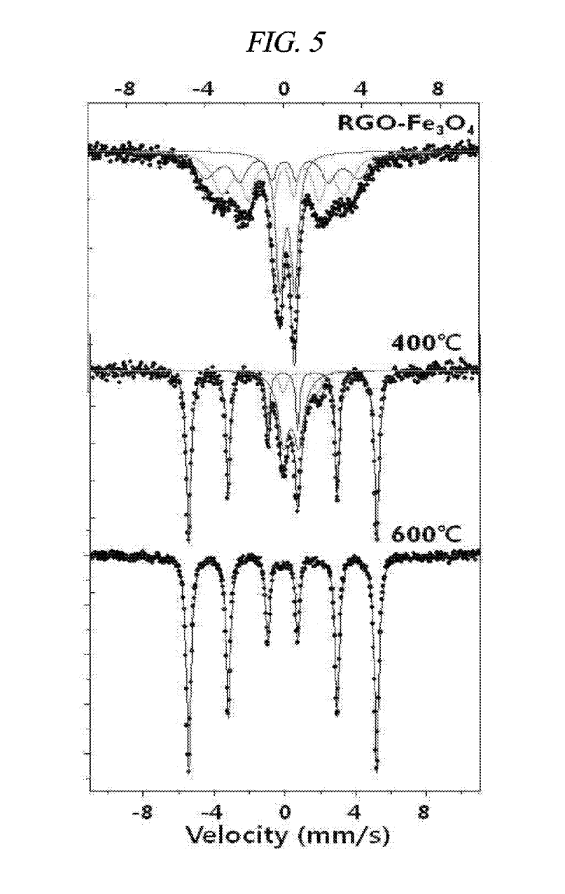

FIG. 5 is a Mössbauer analysis graph illustrating that the composite including the iron component supported on the graphene oxide is changed into zero-valent iron through a heating process in accordance with the present example. A red-colored doublet (double dips) in the middle of the graph represents Fe₃O₄. Two blue-colored and green-colored magnetic sextets (six dips) represent ferric species. The blue-colored magnetic sextets show a result of zero-valent iron. A red-colored doublet line shows a result of Fe₃O₄. A green line shows a super paramagnetic iron oxide magnetically blocked. A sample heat-processed at about 600° C. shows only one magnetic component representing zero-valent iron. It can be seen from the Mössbauer analysis that reduction into the zero-valent iron is completely carried out at about 600° C.

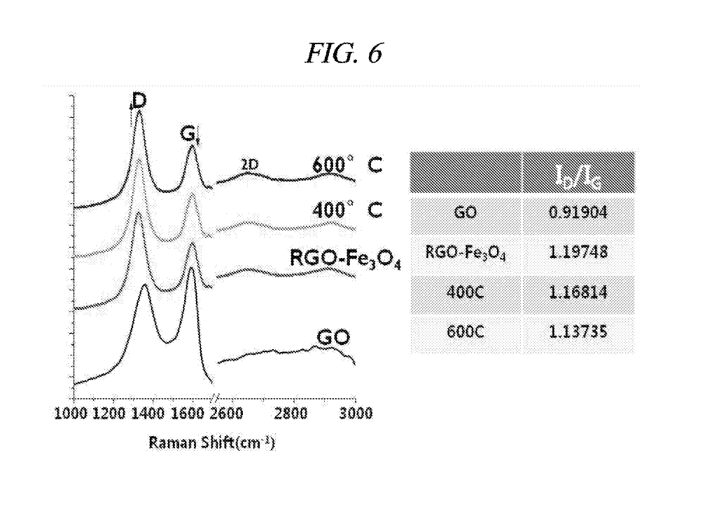

FIG. 6 is a Raman analysis graph illustrating that the composite including the iron component supported on the reduced graphene oxide (RGO) is changed through a heating process in accordance with the present example. A ratio (r=I_{D}/I_{G}) of an intensity of a D band (1335 cm⁻¹) to an intensity of a G band (1600 cm⁻¹) was usually used to measure an irregularity. The RGO-Fe₃O₄ sample has an intensity ratio (r) of about 1.19, about 1.16 in case of a heating process at about 400° C., and about 1.13 in case of a heating process at about 600° C. Their intensity ratio (r) was greater than about 0.91 of the graphene oxide (GO). That meant that there was a defect in a sp²-carbon network of the reduced graphene oxide. A second Raman peak named “2D” was very sensitive to the number of RGO sheets stacked on a c-axis. As the number of RGO sheets staked was increased, a shape of the peak became wider. Therefore, it could be concluded that the samples were very irregular and random RGO plates.

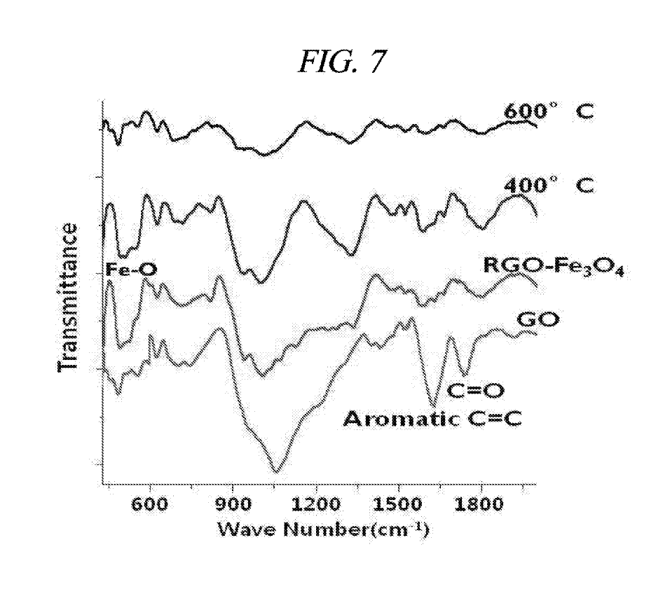

FIG. 7 is an infrared specectroscopic analysis graph illustrating that the composite including the iron component supported on the reduced graphene oxide is changed through a heating process in accordance with the present example. An infrared spectrum of the graphene oxide included C═O (1735 cm⁻¹), aromatic C═C (1625 cm⁻¹), epoxy C═O (1216 cm⁻¹), and alkoxy C—O (1050 cm⁻¹) stretching vibration. In an infrared spectrum of the RGO-Fe₃O₄, a peak was shown at about 1590 cm⁻¹ in case of a heating process at about 400° C., and in case of a heating process at about 600° C., which meant aromatic C═C stretching. A transparent band at about 540 cm⁻¹ shows that Fe—O could be found from the RGO-Fe₃O₄ and the sample heat-processed at about 400° C. The bands shown in the drawing could not be seen from the sample heat-processed at about 600° C. This was because Fe₃O₄ was completely changed into zero-valent iron through the heating process at about 600° C.

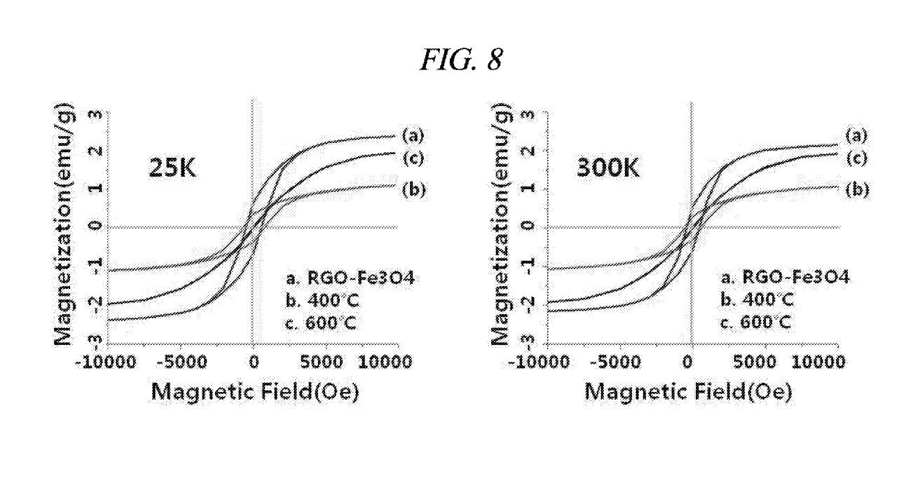

FIG. 8 provides magnetic hysteresisloop graphs illustrating that the composite including the iron component supported on the reduced graphene oxide is changed through a heating process in accordance with the present example. A composite including an iron component supported on a reduced graphene oxide included iron at 25 K and 300 K (room temperature) and showed magnetic hysteresisloops. In FIG. 8, a magnetic intensity of triiron tetraoxide or zero-valent iron supported on a reduced graphene oxide was lower than a magnetic intensity of typical bulk triiron tetraoxide.

Table 1 as shown below shows saturation magnetization (Ms), remanence (Mr), and coercive field (Hc) in the magnetic hysteresisloop graphs obtained from the heating processes performed to the respective composite samples.

TABLE 1

| | temper- | saturation | | coercive field |
|---|---|---|---|---|
| | ature | magnetization | remanence | Coercivity |
| sample | (K) | Ms (emu/g) | Mr (emu/g) | (Hc) (Oe) |
| RGO-Fe₃O₄ | 25 K | 2.41 | 0.75 | <1000 |
| | 300 K | 2.15 | 0.62 | 1000 |
| RGO-Fe₃O₄/ | 25 K | 1.15 | 0.37 | 1000 |
| ZVI | 300 K | 1.12 | 0.25 | 1500 |
| RGO-ZVI | 25 K | 2.04 | 0 | 0 |
| | 300 K | 1.95 | 0 | 0 |

FIG. 9 shows that the composite including the iron component supported on the reduced graphene oxide is heat-processed at about 400° C. and dispersed in water and separated by using a magnetic field in accordance with the present example. FIG. 9 shows that the composite including the iron component supported on the reduced graphene oxide including iron can be easily removed from the water by using the magnetic field.

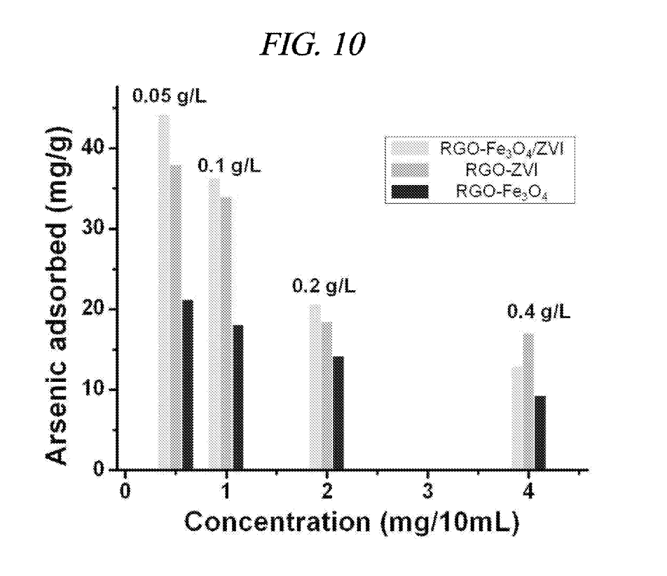

FIG. 10 is a graph showing a concentration of arsenic adsorbed of the composites including the iron component supported on the reduced graphene oxide in accordance with the present example. RGO-Fe₃O₄/ZVI as shown in FIG. 10 was a result of an experiment for removing arsenic by using the composite prepared through the heating process at about 400° C. as shown in FIG. 2. RGO-ZVI as shown in FIG. 10 was a result of an experiment for removing arsenic by using the composite prepared through the heating process at about 600° C. RGO-Fe₃O₄ as shown in FIG. 10 was the composite including the iron component supported on the reduced graphene oxide without a heating process. RGO-Fe₃O₄/ZVI had an average concentration of arsenic adsorbed higher than those of RGO-ZVI and RGO-Fe₃O₄. This was because although ZVI had higher efficiency of removing arsenic than that of a typical iron oxide, each of the composites including an iron component supported on a reduced graphene oxide had a nano porous structure and thus had a much greater surface area. As depicted in FIG. 1, when a heating process for reduction was performed, a gap between graphene layers was maintained by a non-reduced iron oxide in a composite prepared through a heating process at about 400° C., whereas a gap between graphene layers was decreased since the iron oxide was completely changed into ZVI in the composite prepared through a heating process at about 600° C. That is, a surface area was increased due to a porous structure in which the gap between layers was maintained by the iron oxide and the composite including ZVI had higher efficiency of removing arsenic in comparison with the composite including ZVI only.

A BET experiment on each sample as shown in Table 2 supports the above description. Table 2 shows that the sample (RGO-Fe₃O₄/ZVI) heat-processed at about 400° C. had the highest surface area, pore volume, and pore size.

TABLE 2

| | surface area | pore volume | pore size |
|---|---|---|---|
| sample | (m²/g) | (cm³/g) | (nm) |
| RGO-Fe₃O₄ | 44.18 | 0.19 | 1.6 |
| RGO-Fe₃O₄/ZVI | 73.95 | 0.29 | 2.36 |
| RGO-ZVI | 6.89 | 0.04 | — |

That is, a structure of the composite including an iron component supported on a reduced graphene oxide is changed depending on a heating process condition, and heavy metal adsorption capability of the composite can be dependent on porosity which is the most important factor in the structure.

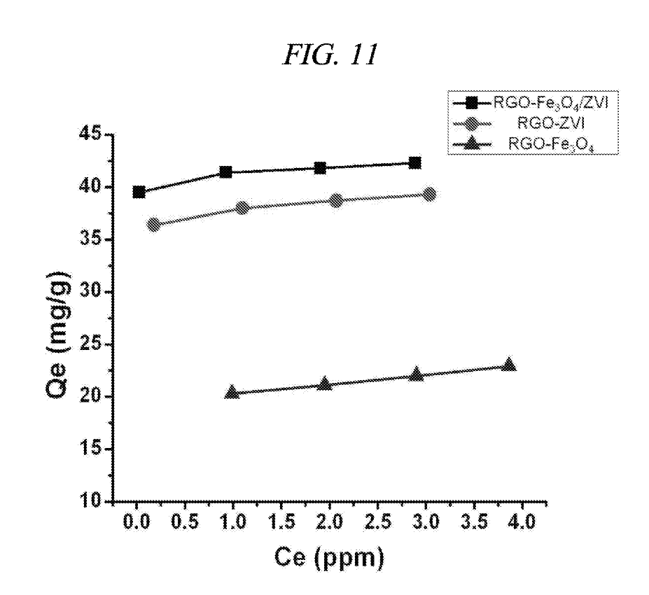

FIG. 11 is a graph showing a relationship between a quantity (Qe) of arsenic adsorbed per adsorbent and an equilibrium concentration (Ce) when the composites including the iron component supported on the reduced graphene oxide are used as an adsorbent in accordance with an example of the present disclosure. When an adsorbent concentration was about 0.05 g/L, the quantity (Qe) of arsenic adsorbed per adsorbent was gradually increased in proportion to an increase in the equilibrium concentration (Ce). RGO-Fe₃O₄/ZVI as an adsorbent had the highest adsorption capability.

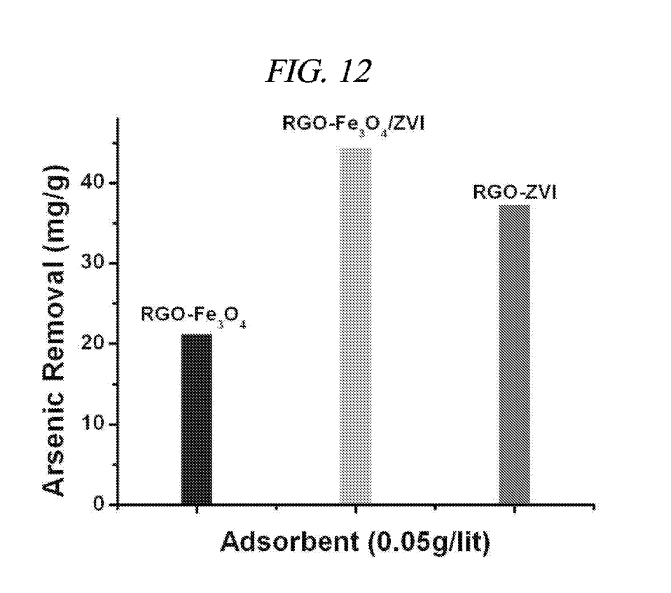

FIG. 12 is a graph showing maximum arsenic adsorption amounts of the composites including the iron component supported on the reduced graphene oxide in accordance with an example of the present disclosure. As for the maximum arsenic adsorption amount when an adsorbent concentration was about 0.05 g/L, RGO-Fe₃O₄/ZVI was highest, followed by RGO-ZVI and RGO-Fe₃O₄.

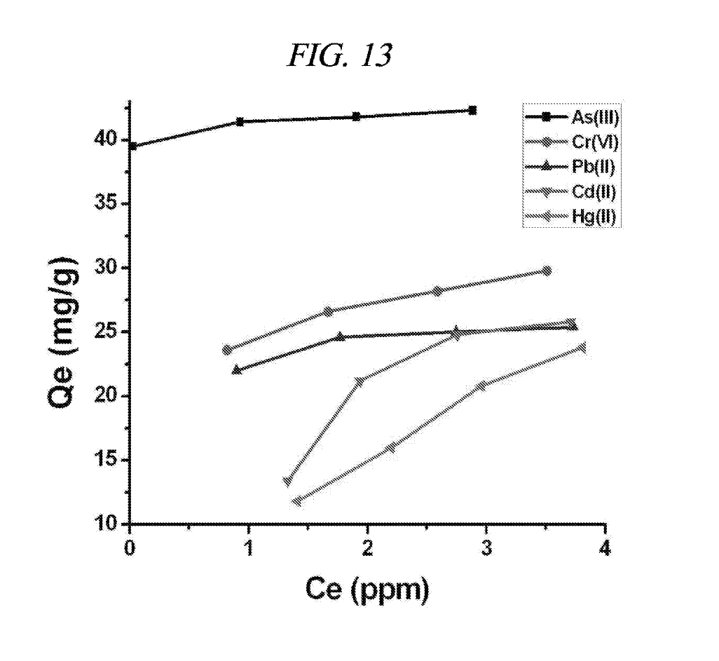

FIG. 13 is a graph showing a relationship between a quantity (Qe) of arsenic (As), chromium (Cr), lead (Pb), cadmium (Cd), and mercury (Hg) adsorbed and an equilibrium concentration (Ce) when the composite including the iron component supported on the reduced graphene oxide is used as an adsorbents of a heavy metal in accordance with an example of the present disclosure. When RGO-Fe₃O₄/ZVI having the highest adsorption in the above-described experiment was used as an adsorbent in an experiment with an adsorbent concentration of about 0.05 g/L, as for the quantity of a heavy metal adsorbed, arsenic was highest, followed by chromium, lead, and cadmium. As the equilibrium concentration was increased, the adsorption capability was slightly increased.

### Example 3

### Adsorption and Removal of Methylene Blue or Methyl Orange as Organic Contaminant

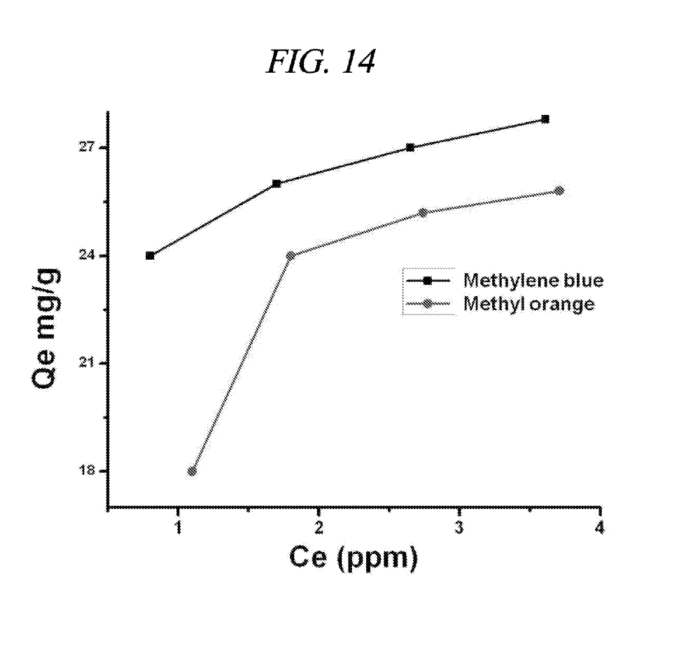

An experiment for adsorbing methylene blue or methyl orange was carried out by using RGO-Fe₃O₄/ZVI as prepared in Example 1. About 0.5 g of RGO-Fe₃O₄/ZVI as one of the adsorbents was added into an aqueous solution in which the methylene blue or methyl orange dissolved at a concentration of from about 2 mg/l to about 5 mg/l and stirred at room temperature for about 20 minutes at a rotation speed of about 60 rpm. Then, the RGO-Fe3O4/ZVI to which the methylene blue or methyl orange was adsorbed was separated from the solution by a magnetic field. After the magnetic separation, a dye supernatant was discarded. Thereafter, the adsorbent to which the methylene blue or methyl orange was adsorbed was added into about 5 ml of ethanol and mixed for about 20 minutes to desorb the methylene blue or methyl orange bonded to the adsorbent. The adsorbent was collected by a magnet and reused for adsorption. As depicted in FIG. 14, a supernatant from which the adsorbent was removed was analyzed with a UV-Vis spectrometer, and FIG. 14 shows a relationship between a quantity (Qe) of methylene blue or methyl orange adsorbed and an equilibrium concentration (Ce) during an adsorption-desorption process.

### Example 4

### Experiment for Removing Microorganism Contaminant

An experiment for removing microorganism contaminants such as Escherichia coli and MS2 coliphage was carried out by using composites such as RGO-ZVI and RGO-Fe₃O₄/ZVI as prepared in Example 1. The Escherichia coli and MS2 coliphage were inactivated by zero-valent iron included in the composites, respectively, so that microorganism contaminants could be removed effectively.

### Example 5

### Experiment for Removing Microorganism Contaminant

After PAX-21 waste water was pre-processed by using composites such as RGO-ZVI and RGO-Fe₃O₄/ZVI as prepared in Example 1, biodegradation of perchlorate contaminants included in the PAX-21 waste water was carried out.

The PAX-21 waste water includes a toxic ingredient such as a nitro aromatic compound [reference: Microbes and Environments, Vol. 24 (2009), No. 1 pp. 72-75.]. The nitro aromatic compound as the toxic ingredient may include 2,4-dinitroanisole (DNAN), n-methyl-4-nitroaniline (MNA), and hexahydro-1,3,5-trinitro-1,3,5-trazine (RDX). Conventionally, the PAX-21 waste water removes perchlorate included in the PAX-21 waste water through biodegradation by using perchlorate respiring bacteria. It has been reported that the toxic ingredient such as the nitro aromatic compound included in the PAX-21 waste water affects a biodegradation rate of the perchlorate [Journal of Hazardous Materials 192 (2011) 909-914.].

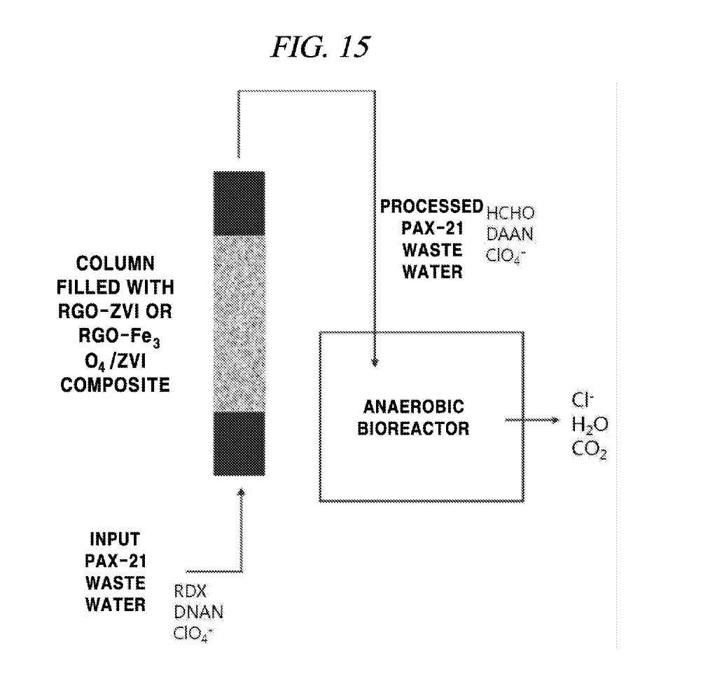

Thus, the PAX-21 waste water was pre-processed with the RGO-ZVI and RGO-Fe₃O₄/ZVI complicates as prepared in Example 1 by using an apparatus as depicted in FIG. 15, so that zero-valent iron included in the composites reduced the nitro aromatic compound, such as 2,4-dinitroanisole (DNAN), n-methyl-4-nitroaniline (MNA), and hexahydro-1,3,5-trinitro-1,3,5-trazine (RDX), as toxic ingredients included in the PAX-21 waste water into 2,4-diaminoanisole (DAAN), 2-methoxy-5-nitroaniline or 4-methoxy-3-nitroaniline, and formaldehyde (ECHO), respectively and improved the following biodegradation of the perchlorate using the perchlorate respiring bacteria.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A composite comprising a metal component supported on graphene,
wherein the metal component comprises zero-valent metal, an oxide of the metal, or a mixture of the zero-valent metal and the oxide of the metal.

2. The composite of claim 1,
wherein the metal component includes zero-valent metal selected from the group consisting of Fe, Pd, Pt, Au, Ru, Ir, Rd, Ti, Co, Ni, Cu, Zn, Cr, V, Al, Sn, In, Ce, Mo, Ag, Se, Te, Y, Eu, Nb, Sm, Nd, Ga, Gd, and combinations thereof, an oxide of the metal, or a mixture of the zero-valent metal and the oxide of the metal.

3. The composite of claim 1,
wherein the graphene includes a reduced graphene oxide.

4. The composite of claim 1,
wherein the composite is porous.

5. (canceled)

6. The composite of claim 1,
wherein a weight ratio of the oxide of the metal to the zero-valent metal is in a range of from 1:1 to 1:5.

7. The composite of claim 1,
wherein the graphene includes a multiple number of graphene layers, and the metal component is intercalated between the graphene layers or supported on surfaces of the graphene layers.

8. The composite of claim 1,
wherein the oxide of the metal as the metal component is intercalated between layers of the graphene and the zero-valent metal as the metal component is supported on surfaces of the graphene layers.

9. The composite of claim 1,
wherein the metal component is formed in nanoparticles.

10. A composition for removing a contaminant comprising the composite of claim 1.

11. The composition of claim 10,
wherein the contaminant removing composition is used to remove a contaminant included in water or an organic solvent.

12. The composition of claim 10,
wherein the contaminant is selected from the group consisting of a heavy metal or a cation thereof, an organic contaminant, an inorganic contaminant, an microorganism, and combinations thereof.

13. (canceled)

14. (canceled)

15. A method of removing a contaminant, comprising:
adsorbing and removing a contaminant by using the composite of any one of claim 1.

16. The method of claim 15,
wherein the contaminant is included in water or an organic solvent.

17. The method of claim 15,
wherein the composite is filled in a fixed-bed column or supported on a fixed-bed surface.

18. The method of claim 15,
wherein the contaminant is selected from the group consisting of a heavy metal or a cation thereof, an organic contaminant, an inorganic contaminant, a microorganism, and combinations thereof.

19. (canceled)

20. (canceled)

21. A method of preparing the composite of any one of claim 1, the method comprising:
preparing an aqueous solution that includes a graphene oxide and a metal compound;
reducing the graphene oxide by adding an alkaline solution as a reducer to the aqueous solution to obtain a mixed solution that includes a metal oxide supported on a reduced graphene oxide;
removing a solvent included in the mixed solution to obtain a mixture including the metal oxide supported on the reduced graphene oxide; and
heating the mixture including the metal oxide supported on the reduced graphene oxide to reduce all or a part of the metal oxide under a reducing atmosphere.

22. The method of claim 21,
wherein the method is performed in an inert atmosphere.

23. (canceled)

24. (canceled)

25. The method of claim 21,
wherein a heating temperature during the heating is in a range of from 400° C. to 600° C.

26. (canceled)

27. The method of claim 21,
wherein the metal compound includes a halide salt of the metal.

28. The method of claim 21,
wherein the reducer is selected from the group consisting of H₂, NaBH₄, SO₂, CH₄, NH₃, N₂H₄, H₂S, HI, and combinations thereof.

29. (canceled)

30. (canceled)

31. (canceled)
